(19) United States
(12) Patent Application Publication
(10) Pub. No.: US 2008/0024067 A1
(43) Pub. Date: Jan. 31, 2008

(54) LED lighting device

(76) Inventor: Kazuo Ishibashi, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 11/878,287

(22) Filed: Jul. 23, 2007

(30) Foreign Application Priority Data
Jul. 26, 2006 (JP) JP2006-203778

(51) Int. Cl. F21V 29/00

(52) U.S. Cl. 315/112

(57) ABSTRACT

An LED lighting device has high cooling efficiency and long life with a plurality of high-intensity LEDs mounted thereto. The LED lighting device is composed of a light emission part provided with a plurality of LEDs and a heat radiator for the LEDs, a power source part generating a current to be supplied to the LEDs from a commercial power source, and an air circulation part for circulating ambient air. The light emission part and the power source part are thermally separated by the air circulation part. The light emission part is provided with an annular heat radiation base having a hole formed at a central portion thereof and a substrate attaching face formed around the hole, and an LED substrate which is attached to the substrate attaching face and on which a plurality of LED chips are mounted. The heat radiation base has heat radiation fins as the heat radiator which are formed on an outer periphery of the heat radiation base and on an inner periphery of the hole. By the presence of the air circulating part, little heat generated from the power source part is transmitted to the light emission part. Therefore, it is possible to accomplish desired designing of heat radiation of the light emission part concerned with intensity and life of an LED, which is critical to performance of an LED lighting device.

### BACKGROUND OF THE INVENTION

1. Field of the Invention

The present invention relates to an LED (light-emitting diode) lighting device capable of controlling temperature rise of an LED which is a problem when using a high-intensity LED as a lighting device.

2. Description of the Related Art

As commercialization of blue LEDs and white LEDs was realized, researches for employing LEDs instead of incandescent light bulbs or fluorescent lamps as a light source for lighting devices have been conducted, and some LED lighting devices have already been produced on a commercial basis.

In the case of an LED using a chip having a p-n junction composed of a p-type semiconductor and an n-type semiconductor, when a voltage is applied to the LED chip in a forward direction, a current flowing in the p-type semiconductor (a hole) and an electron flowing in the n-type semiconductor that collide with each other recombine around the junction. Then, the initial energy of the electron and the hole becomes smaller to generate surplus energy, which produces optical emission as photon energy. This is the principle of light emission by LEDs.

When light is emitted as described above, the energy is not wholly converted into light energy and emitted. Instead, a part of the energy is changed to heat, which increases the temperature of encapsulating resin around the junction. Due to this heat, the resin deteriorates with the passage of time. Such deterioration of resin leads to a decrease in penetration of light, which shortens the lifespan of the LED.

In order to release the heat around a junction of an LED, conventionally, various kinds of cooling means have been used. In recent years, particularly, high-intensity LEDs are being produced on a commercial basis, and thus use of cooling means has become indispensable for maintaining the high intensity. Furthermore, when several white LEDs are mounted to produce a lighting device, the total heat value becomes large, requiring more efficient cooling means.

As a conventionally used LED lighting device, for example, Unexamined Japanese Patent Publication No. 2001-243809 discloses an LED light bulb having a power supply circuit for converting an alternate current to a direct current provided inside a substantially spherical body. The LED light bulb is provided with a base on one end, a bugle-shaped metal heat radiation part expanding like a bugle toward an opening part on the other end, a translucent cover attached to an opening part of the bugle-shaped metal heat radiation part, a metal substrate provided inside the substantially spherical body formed by the bugle-shaped metal heat radiation part and the translucent cover, and an LED element mounted on an outer surface of the metal substrate facing the translucent cover.

An LED lighting device described in Unexamined Japanese Patent Publication No. 2006-40727 is provided with a plurality of LEDs, a printed circuit board to which each of the LEDs is mounted, a container having holes each of which light emitted from each of the LEDs passes through, respectively, and housing the printed circuit board with each light-emitting part of the LEDs facing the respective hole, a connection part formed in the same shape as a shape of a base of a light bulb to be electrically and mechanically connected to a socket for a light bulb, and a power source part to which a power source is supplied via the connection part to generate a power source for each of the LEDs. On the outer surface of the container, a plurality of heat radiation fins are formed so as to project from the surface, and each of the LEDs is located at a position near an inner surface of the container.

In the above-described Unexamined Japanese Patent Publication No. 2001-243809, the surface of the bugle-shaped metal heat radiation part has contact with ambient air so that heat generated from the LED is released from the bugle-shaped metal heat radiation part to an outside. In Unexamined Japanese Patent Publication No. 2006-40727, the heat radiation fins formed on the outer surface of the container has contact with ambient air, thereby releasing heat generated from the LED to an outside.

However, in either of the above-described references, the LEDs, which generate heat, and the power supply circuit or the power source part, which is another heat source, are housed in the same closed space such as the substantially spherical body or the container.

For an LED lighting device used by inserting the device into a socket for 100V as in conventional light bulbs, it is necessary to provide a power source unit housed in the lighting device for full-wave rectification of an alternate current of 100V to a direct current to flow a predetermined constant current to the LED. Such a power source unit includes a diode, a transistor and a resistor, and thus generates heat therein. From the LED, additional heat is generated.

As described above, high-intensity LEDs have been commercialized in recent years. The gross heating value is raised accordingly and, therefore, an efficient heat radiation means is required for maintaining the high intensity. On the other hand, the heat not only from LEDs but also from power source units render the design for heat radiation complicated requiring the release of the heat from both parts. Insufficient heat radiation and low cooling efficiency shortens the lifespan as an LED lighting device.

In view of the foregoing, an object of the present invention is to provide an LED lighting device having high cooling efficiency and long life even with a plurality of high-intensity LEDs mounted thereto.

### SUMMARY OF THE INVENTION

In order to solve the above-described problems, a first structure of an LED lighting device of the present invention is an LED lighting device comprising a light emission part provided with a plurality of LEDs and a heat radiator for the LEDs, a power source part generating a current to be supplied to the LEDs from a commercial power source, and an air circulation part for circulating ambient air, the air circulation part thermally separating the light emission part and the power source part.

In the first structure, since the light emission part and the power source part are thermally separated by the air circulation part provided between them, little heat generated from heating of the power source part is transmitted to the light emission part. Therefore, it is possible to accomplish desired design for heat radiation of the light emission part concerned with intensity and life of an LED, which is critical to performance of an LED lighting device.

A second structure of the present invention is, in the LED lighting device of the first structure, the light emission part is provided with an annular heat radiation base having a hole formed at a central portion thereof and a substrate attaching face formed around the hole, and an LED substrate which is attached to the substrate attaching face and on which a plurality of LED chips are mounted, the heat radiation base having heat radiation fins as the heat radiator which are formed on an outer periphery of the heat radiation base and on an inner periphery of the hole.

In the second structure of the light emission part and the heat radiator as described above, heat which is generated in a junction and an encapsulating resin part of a plurality of LED chips heated by lighting is transmitted from the substrate attaching face of the heat radiation base to an area of lower temperature. In other words, the fins formed on a surface of the heat radiation base have contact with ambient air and thus is cooled by convection of the air or the like. In the present invention, since the fins for heat radiation are provided not only on the outer periphery of the heat radiation base but also on the inner periphery of the hole of the heat radiation base, efficiency of heat radiation is improved, and temperature rise can be controlled even when a plurality of high-density LEDs are mounted.

In the second structure, if another set of heat radiation fins are formed on a rear surface of the heat radiation base, convection of the air flowing up and down is brought into contact with the fins on either of the outer periphery of the heat radiation base, the inner periphery of the hole, or the rear surface of the heat radiation base irrespective of the arranging direction of the LED lighting device, thereby improving the heat radiation effect.

### BRIEF DESCRIPTION OF THE DRAWINGS

In the accompanying drawings:

FIG. 1A is a front view illustrating an LED lighting device according to a first embodiment of the present invention;

FIG. 1B is a side view illustrating the LED lighting device in FIG. 1A;

FIG. 2 is a longitudinal sectional side view illustrating the LED lighting device according to the first embodiment of the present invention;

FIG. 3A is a plan view illustrating a heat radiation base of the LED lighting device according to the first embodiment of the present invention, to which an LED substrate is attached;

FIG. 3B is a rear view of the heat radiation base in FIG. 3A;

FIG. 3C is a partially cut-out front view of the heat radiation base in FIG. 3A;

FIG. 4A is a front view illustrating an LED lighting device according to a second embodiment of the present invention;

FIG. 4B is a side view illustrating the LED lighting device in FIG. 4A; and

FIG. 5 is a perspective view illustrating another embodiment of a heat radiation base.

### DETAILED DESCRIPTION OF THE PREFERRED EMBODIMENT

Preferred embodiments are explained below with reference to the accompanied drawings.

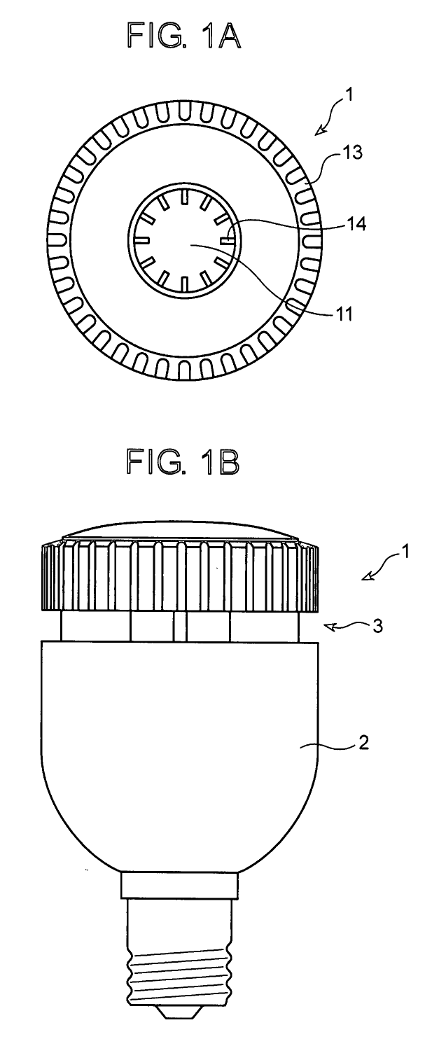

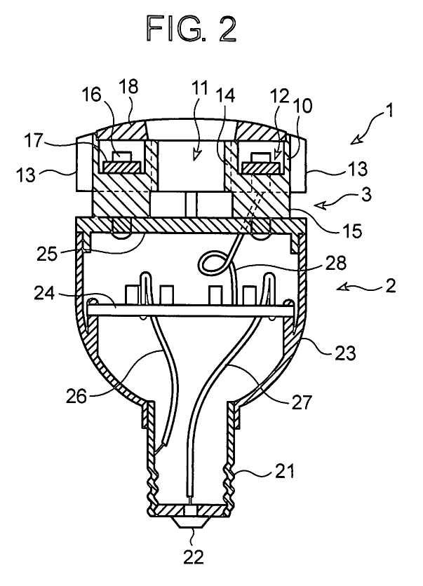

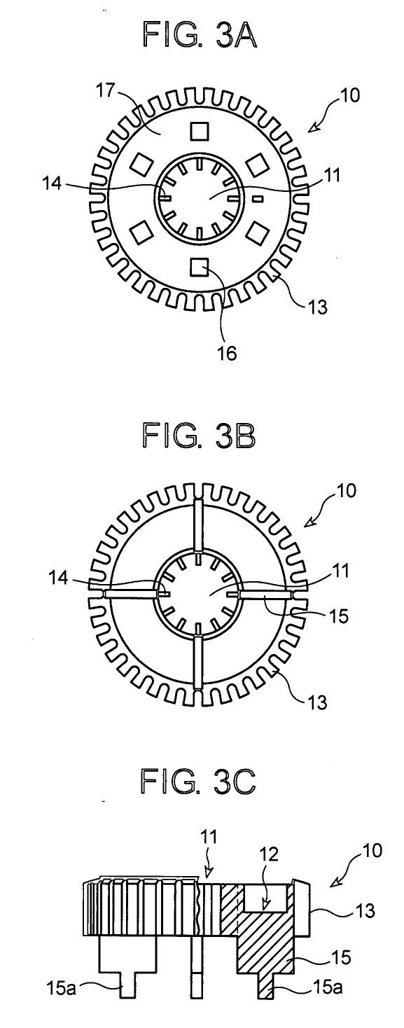

FIG. 1A is a front view illustrating an LED lighting device according to a first embodiment of the present invention; FIG. 1B is a side view thereof; FIG. 2 is a longitudinal sectional side view of the same; FIG. 3A is a plan view illustrating a heat radiation base of the LED lighting device according to the first embodiment of the present invention, to which an LED substrate is attached; FIG. 3B is a rear view thereof; and FIG. 3C is a partially cut-out front view of the heat radiation base.

An LED lighting device according to the first embodiment of the present invention is composed of a light emission part 1 provided with LEDs and a heat radiator for the LEDs, a power source part 2 generating a current to be supplied to the LEDs from a commercial power source, and an air circulation part 3 for circulating ambient air. The light emission part 1 and the power source part 2 are thermally separated by the air circulation part 3. The light emission part 1 is, as shown in FIG. 2, provided with a heat radiation base 10 made of aluminum alloy which basically has an annular shape having a hole 11 at a central portion thereof. The heat radiation base 10 has, on one face (front face) which is perpendicular to a central axis of the hole 11, a substrate attaching face 12 for attaching an LED substrate 17 on which a plurality of LED chips 16 are mounted in a circular pattern. On an outer periphery of the heat radiation base 10 and on an inner periphery of the hole 11, fins 13 and 14 are integrally formed, respectively. On a rear face of the heat radiation base 10, leg portions 15 are provided in a radial pattern to form the air circulation part 3. In this embodiment, the number of the leg portions 15 is four.

A front face of the heat radiation base 10 is covered with an opaque white translucent cover 18 which radiates light emitted from the plurality of LED chips 16 (six chips in this embodiment) mounted on the LED substrate 17 and diffuses the light in a planar form.

The power source part 2 is provided with a screw base 21 to be screwed to a socket of a lighting device using a commercial power source (100V), a contact 22 which is insulated from the screw base 21, a case 23 made of insulating material such as plastic of which base end portion is adhered and fixed to the screw base 21, a power source substrate 24 fixed to an inside of the case 23 with a screw or an adhesive, and a cover plate 25 for closing an opening on a top of the case 23 and for fixing the leg portions 15 of the heat radiation base 10 thereto. In the present embodiment, the heat radiation base 10 is fixed to the cover plate 25 by inserting fixing tabs 15a formed on distal ends of the leg portions 15 into holes formed in the cover plate 25 and bending or turning protruding portions of the fixing tabs 15a. However, other fixing means such as screws may be employed.

Inside the case 23, lead wires 26 and 27 are connected to the screw base 21 and the contact 22 by soldering or the like at base ends thereof and to terminals of the power source substrate 24 at distal ends thereof. Electric power which has been converted from AC 100V to a constant direct current by electric or electronic components mounted on the power source substrate 24 is led to the LED substrate 17 provided on the substrate attaching face 12 of the heat radiation base 10 by a lead wire 28, thereby supplying a predetermined current to the LED chips 16.

In each of the cover plate 25 and the heat radiation base 10, a hole for passing the lead wire 28 is formed. In the cover plate 25, it is also possible to form a hole for cooling air inside the case 23. In this case, the position and size of the hole must be designed so as to meet the safety standard for preventing electric shock or the like.

In the first embodiment described above, by putting the screw base 21 into a socket of the same type as an incandescence light bulb, a voltage of 100V alternate current is supplied from the screw base 21 and the contact 22 to a circuit of the power source substrate 24 through the lead wires 26 and 27. Then, a direct current of a predetermined voltage is generated by electric or electronic components mounted on the power source substrate 24, including a resistor, a diode, a zener diode, or a transistor, thereby supplying a predetermined current to the LED substrate 17 through the lead wire 28.

Heat generated from a resistor or a semiconductor component mounted on the power source substrate 24 increases the temperature of the air inside the case 23, which, however, is cooled down by a surface of the case 23. On the other hand, heat generated when the plurality of LED chips 16 mounted on the LED substrate 17 emit light is transmitted to the heat radiation base 10 and released to the outside from the fins 13 on the outer periphery, the fins 14 on the inner periphery of the hole 11, and the leg portions 15. Air which is brought into contact with surfaces of the fins 13 and 14 and the leg portions 15 and heated decreases in its specific gravity and goes up, causing convection, thereby being replaced by the air having lower temperature. At this time, depending on the direction of the LED lighting device in use, the fins that are located at the positions hindering the convection of the air brought into contact with the fins 13 and 14 has lower cooling efficiency. However, since the fins 13, the fins 14 and the leg portions 15 are disposed at different positions toward different directions, respectively, either of the fins or leg portions contributes to improvement in cooling efficiency, which leads to enhancement of heat radiation effect as a whole.

Furthermore, heat generated from the power source part 2 is separated from the light emission part 1 by the leg portions 15, and gaps between the leg portions 15 serve as the air circulation part 3. Therefore, the heat generated from the power source part 2 does not affect the light emission part 1, and thus it is sufficient to take into account only the structure of the heat radiation from the heat radiation part 10, which facilitates designing of the device.

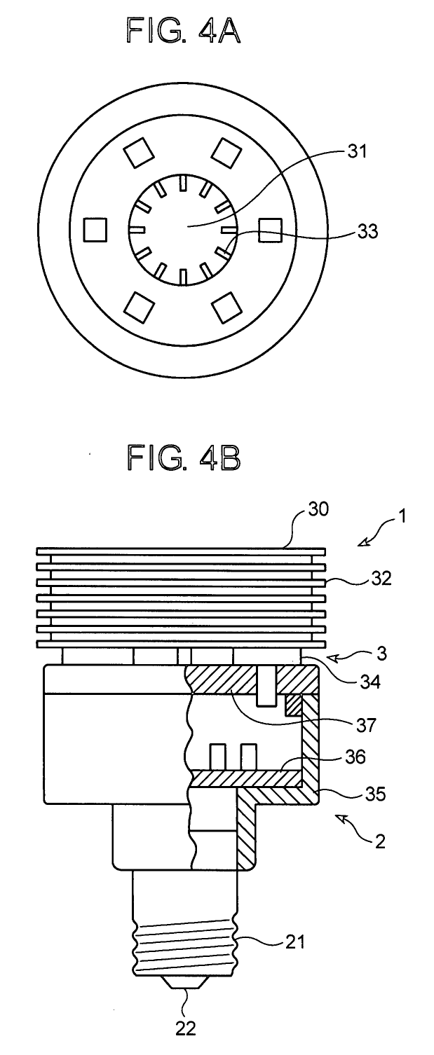

FIG. 4A is a front view illustrating an LED lighting device according to a second embodiment of the present invention, and FIG. 4B is a side view illustrating the LED lighting device in FIG. 4A.

As shown in FIG. 4A, an LED lighting device according to the second embodiment of the present invention is composed of a light emission part 1 provided with LEDs and a heat radiator for the LEDs, a power source part 2 generating a current to be supplied to the LEDs from a commercial power source, and an air circulation part 3 for circulating ambient air. The light emission part 1 and the power source part 2 are thermally separated by the air circulation part 3. The light emission part 1 is provided with a heat radiation base 30 made of aluminum alloy which basically has an annular shape having a hole 31 at a central portion thereof. On an outer periphery of the heat radiation base 30 and an inner periphery of the hole 31, fins 32 and 33 are integrally formed, respectively. On a rear surface of the heat radiation base 30, leg portions 34 are provided in a radial pattern to form the air circulation part 3. In this embodiment, the number of the leg portions 34 is four.

The power source part 2 is provided with a screw base 21 to be screwed to a socket of a lighting device using a commercial power source (100V), a contact 22 which is insulated from the screw base 21, a case 35 made of insulating material such as plastic of which base end portion is adhered and fixed to the screw base 21, a power source substrate 36 fixed to an inside of the case 35 with a screw or an adhesive, and a cover plate 37 for closing an opening on a top of the case 35 and for fixing the leg portions 34 of the heat radiation base 30 thereto.

The second embodiment differs from the first embodiment in that the plurality of fins 32 formed on the outer periphery of the heat radiation base 30 extend in a direction perpendicular to a central axis of the hole 31 of the heat radiation base 30 and are layered in a direction parallel to the central axis and that the case 35 is formed in a two-staged cylindrical shape. By forming the fins 32 in the direction as described above, when the LED lighting device is arranged to face in a lateral direction in use, the heat radiation effect is improved compared to the fins 13 directed as in the first embodiment.

Since the remaining structures and actions of the second embodiment are the same as those of the first embodiment, the explanations are omitted.

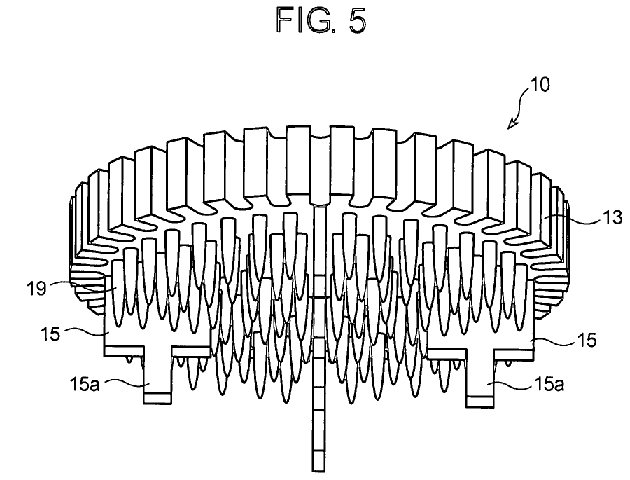

As shown in FIG. 5, it is possible to form a number of rod-like auxiliary fins 19 on a rear surface of the heat radiation base 10 to further improve the heat radiating property.

While there has been described what is at present considered to be a preferred embodiment of the invention, it will be understood that various modifications may be made thereto, and it is intended that the appended claims cover all such modifications as fall within the true spirit and scope of the invention.

What is claimed is:

1. An LED lighting device comprising:
a light emission part provided with a plurality of LEDs and a heat radiator for the LEDs,
a power source part generating a current to be supplied to the LEDs from a commercial power source, and
an air circulation part for circulating ambient air, the air circulation part thermally separating the light emission part and the power source part.

2. The LED lighting device according to claim 1, wherein said light emitting part comprises:
an annular heat radiation base having a hole formed at a central portion thereof and a substrate attaching face formed around the hole, and
an LED substrate which is attached to the substrate attaching face and on which a plurality of LED chips are mounted,
said heat radiation base having heat radiation fins as the heat radiator which are formed on an outer periphery of the heat radiation base and on an inner periphery of the hole.

3. The LED lighting device according to claim 2, further comprising heat radiation fins formed on a rear surface of the heat radiation base.
